(19) United States
(12) Patent Application Publication
(10) Pub. No.: US 2010/0044370 A1
(43) Pub. Date: Feb. 25, 2010

(54) CONTAINER FOR LAUNDRY DETERGENT MOLDINGS

(75) Inventors: Wolfgang Barthel, Langenfeld (DE); Frank Meier, Dusseldorf (DE)

Correspondence Address: CONNOLLY BOVE LODGE & HUTZ LLP, PO BOX 2207, WILMINGTON, DE, 19899-2207, US

(73) Assignee: Henkel AG & Co. KGaA, Dusseldorf (DE)

(21) Appl. No.: 12/521,885

(22) PCT Filed: Oct. 23, 2007
(86) PCT No.: PCT/EP07/61306

§ 371 Date: Jul. 1, 2009

(30) Foreign Application Priority Data
Jan. 8, 2007 (DE) 10 2007 001 996.5

(51) Int. Cl. B65D 8/00; B23P 19/04; B05B 7/00

(52) U.S. Cl. 220/4.25; 29/700; 222/630

(57) ABSTRACT

A container (1) for adding detergent molded bodies to the washing drums of washing machines has a first hemispherical container tray (3), and a second hemispherical container tray (4), wherein the first container tray (3) and the second container tray (4) in the assembled state form a receiving chamber or volume into which the detergent molded body is positioned. The container trays (3, 4) are formed by a plurality of abutting individual bodies (6), wherein each individual body (6) is in contact with at least four of the individual bodies surrounding the same. Intermediate spaces (7) are formed between the individual bodies (6) by the geometry of the individual bodies (6) and/or the positions thereof in relation to each other. The intermediate spaces (7) allow an exchange of washing water between the receiving chamber and the surrounding area of the container (1). The walls of the container trays (3, 4) shaped in this way are flexible.

### RELATED APPLICATIONS

This application is a national stage application (under 35 U.S.C. §371) of PCT/EP2007/061306, filed Oct. 23, 2007, which claims benefit of German application 102007001996.5, filed Jan. 8, 2007.

### BACKGROUND

The invention relates to a container for introducing laundry detergent moldings into the drum of washing machines.

Laundry detergents are today primarily designed for one-off dispensing. In other words, for each individual washing process with an appropriate washing machine, the necessary laundry detergent, which frequently assumes powder or granular form, must be measured out by the user and placed in the dispensing chamber provided for this purpose.

Preportioned laundry detergents, such as for example laundry detergent moldings (tablets) or preportioned laundry detergents in water-soluble film are also known, but these may in each case be used for only a single washing cycle.

The prior art discloses, for example, containers for providing multiple dispensing over a plurality of washing cycles, which containers are filled with a sufficient quantity of laundry detergent for a plurality of washing cycles and are placed in the washing machine drum, where they remain over a plurality of washing cycles until the quantity of laundry detergent has been consumed.

EP964951, for example, discloses such a dispensing device for washing laundry in a washing machine, in which a laundry detergent molding, for example a laundry detergent tablet, is placed in a net comprising apertures which allow washing water to pass into and out of the net. One substantial disadvantage of this dispensing device is that the laundry detergent molding located in the net is not protected by the net from the mechanical stresses in the washing machine drum during the washing process and may thus break up comparatively easily.

Dimensionally stable dispensing devices to overcome this disadvantage have also been proposed in the prior art. EP964952, for example, discloses a dimensionally stable dispensing device for accommodating a laundry detergent tablet and which comprises a plurality of openings for the passage of washing water.

Such dimensionally stable dispensing devices have the disadvantage, however, that their hard surfaces are capable of causing mechanical damage to the material being washed. This is a problem in particular with soft textiles such as wool. Moreover, such dimensionally stable dispensing devices cause troublesome noises in the drum during a washing cycle.

### SUMMARY OF THE INVENTION

An object of the invention is therefore to overcome the problems known from the prior art and to provide a dispensing device which generates little noise and is gentle on laundry together with a method for inexpensively producing the dispensing device.

For the purposes of the present application, an adjoining arrangement of the individual bodies means that the individual bodies are in contact with surrounding individual bodies.

Thanks to its globular shape and the flexible container walls, the container according to the invention generates little noise and is gentle on laundry, the laundry detergent molding being sufficiently well protected from mechanical stresses in the accommodation space of the container to prevent mechanical damage to the laundry detergent molding, such as for example breaking up.

A further advantage of the container according to the invention is that the product enclosed in the container cannot be removed, so making the container substantially child-safe.

Once the laundry detergent located in the container has been completely consumed, the container may also be used as a toy ball, whereby the container, after being used as a dispensing device for laundry detergent, may be put to a secondary use, whereby the container does not become waste.

The container according to the invention achieves the above-explained result with a structurally very simple and easily handled solution.

Preferred developments and further developments of the container are the subject matter of the subclaims.

It is particularly preferred for the individual bodies to be substantially spherical. It is very particularly preferred for the spherical individual bodies to have the same diameter. Diameters of 3 mm to 10 mm are preferred, with diameters of 5 mm to 6 mm being very particularly preferred.

The spherical individual bodies may be arranged in parallel layers relative to one another.

It is likewise advantageous to configure the interspaces between the individual bodies such that they exhibit an aperture area equivalent to a circular area with a diameter of less than 3 mm, preferably of less than 1 mm. This ensures, on the one hand, that washing water can pass freely through the container and, on the other hand, that the laundry detergent molding is still adequately protected from mechanical action by the container.

The individual bodies are preferably joined to one another by a materially bonded joint, in particular by sintering or adhesion. Frictional and/or interlocking joints are, however, also conceivable. The flexibility of the container wall can be precisely adjusted by the geometry of the individual bodies and the nature of the in particular materially bonded joint.

In order still further to minimize noise generation and still further to improve the gentle treatment of textile surfaces during a washing cycle, it is advantageous for the Shore A hardness values of the individual bodies to be less than 200. In this connection, it is particularly preferred to select Shore A hardness values for the individual bodies of between 60 and 90.

It has moreover proved advantageous for the container to have a diameter of less than 20 cm, preferably of between 8 cm and 10 cm.

In a particularly preferred embodiment of the container according to the invention, the individual bodies are configured such that they release an active substance into the surroundings.

The active substances may be bound to or dissolved in the individual bodies.

For the purposes of the present application, an active substance is taken to mean a substance or mixture of substances which, by mixing with the product located in the container, is suitable for bringing about or influencing, in particular improving, producing, emphasizing or attenuating, a property of the product, for accelerating or retarding a process which proceeds over time, or for initiating, inhibiting or catalyzing a reaction.

An active substance should furthermore also be taken to mean a substance or mixture of substances which is suitable for bringing about or influencing a property of the container, in particular fragrance and/or active ingredient release, adsorption or absorption on or in the container.

The individual bodies may comprise one or more identical or different active substances from the group of fragrances, bleaching agents, cleaning substances, solvents, catalysts, surfactants, dyes, enzymes, hygroscopic substances, flame-retardants, curing agents, leveling agents, wetting agents, dispersants, foaming agents, defoamers, deaerating agents, corrosion protection agents, biocides, water softeners, preservatives, emulsifiers, stabilizers, vitamins, minerals and the like.

According to a preferred embodiment of the invention, the active substances are bound onto or in a polymeric support material. Fragrances and/or catalysts are particularly preferably bound in or onto a polymeric support material.

### DESCRIPTION OF THE DRAWING

The invention is illustrated in greater detail below with reference to a drawing which represents merely exemplary embodiments. Particularly preferred developments and particularly preferred combinations of features are also further described in detail. In the drawings:

FIG. 1 shows a perspective view of the container.

### REFERENCE NUMERALS

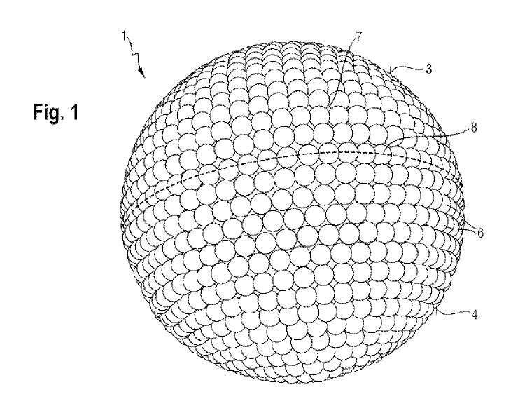

1 Container
2 Laundry detergent molding (not shown in FIG. 1)
3 Container shell
4 Container shell
5 Accommodation space (not shown in FIG. 1)
6 Individual bodies
7 Interspace
8 Abutment edge

### DESCRIPTION OF AN EMBODIMENT

FIG. 1 shows a perspective view of the container 1 according to the invention for accommodating a laundry detergent molding or tablet.

The container 1 has a substantially globular shape and is formed from a first hemispherical container shell 3 and a second hemispherical container shell 4, which are joined together, in particular by material bonding, along an abutment edge 8.

The two container shells may also be joined to one another by suitable interlocking and/or frictional, detachable or non-detachable, joints. Snap-fit, latching or screwed joints may in particular prove advantageous.

The container shells 3, 4 are in each case formed from a plurality of adjacent individual bodies 6, the individual bodies 6 in the exemplary embodiment shown exhibiting a substantially spherical configuration.

The first container shell 3 and the second container shell 4 form in the assembled state an accommodation space or inner volume, into which a laundry detergent molding is placed, but such laundry detergent molding is not visible in FIG. 1.

Each of the spherical individual bodies 6 is in contact with at least four of the individual bodies 6 surrounding it, i.e. each of the spherical individual bodies 6 is joined, preferably by a material bond, with at least four of the individual bodies surrounding it. The materially bonded joint may be brought about, for example, by adhesive bonding, welding or sintering.

Thanks to the spherical geometry of the individual bodies 6 and their position relative to one another, interspaces 7 are formed between the individual bodies 6, which interspaces 7 permit an exchange of washing water between the accommodation space and the surroundings of the container 1.

Furthermore, thanks to the suitable arrangement of the individual bodies and a corresponding mesh-like interconnection of the individual bodies, the consequently formed walls of the container shells 3, 4 are flexible.

As is apparent from FIG. 1, the individual bodies 6 are arranged, relative to the abutment edge, in parallel lines relative to one another.

The container 1 according to the invention filled with a laundry detergent molding is produced by initially forming the first container shell 3 and the second container shell 4. The laundry detergent molding is then placed in the first container shell 3. Finally, the second container shell 4 is placed on the first container shell 3 and joined together along the abutment edge 8, such that the laundry detergent molding is completely enclosed by the container shells 3, 4.

The invention is, of course, not limited to the described exemplary embodiment. Further developments are possible without extending beyond the scope defined in the claims.

1. A container for introducing a laundry detergent molding into the drum of a washing machine, comprising:
a substantially globular container (1) with
a first hemispherical container shell (3) and
a second hemispherical container shell (4)
the first container shell (3) and the second container shell (4) forming in the assembled state an accommodation space, in which the laundry detergent molding may be placed,
wherein
the container shells (3, 4) are formed from a plurality of adjacent individual bodies (6), each individual body (6) being in contact with at least four of the individual bodies surrounding it with interspaces (7) formed between the individual bodies (6), so that washing water may enter and exit the accommodation space through said interspaces (7).

2. The container as claimed in claim 1, wherein the individual bodies (6) are substantially spherical.

3. The container as claimed in claim 1, wherein the spherical individual bodies (6) have a diameter within the range of about 3 mm to 10 mm.

4. The container as claimed in claim 2, wherein the spherical individual bodies (6) are arranged in parallel layers to one another.

5. The container as claimed in claim 2, wherein at least one interspace (7) comprises an aperture area equivalent to a circular area with a diameter of less than about 3 mm.

6. The container as claimed in claim 1, wherein the individual bodies (6) are joined to one another by material bonding.

7. The container as claimed in claim 1, wherein the individual bodies (6) have a Shore A hardness of less than 200.

8. The container as claimed in claim 1, wherein the container (1) has a diameter of less than 20 cm.

9. The container as claimed in claim 1, wherein the individual bodies (6) release active substance to surroundings.

10. The container as claimed in claim 9, wherein the active substance is a fragrance.

11. The container as claimed in claim 10, wherein the active substance is a catalyst.

12. A method for making a container filled with a laundry detergent molding for use in a washing machine, comprising:
forming a first hemispherical container shell having a plurality of adjacent individual bodies, each individual body being in contact with at least four of the individual bodies surrounding it, with interspaces formed between the individual bodies,
forming a second hemispherical container shell having a plurality of adjacent individual bodies, each individual body being in contact with at least four of the individual bodies surrounding it, with interspaces formed between the individual bodies,
placing the laundry detergent molding into the first container shell,
joining the first container shell to the second container shell along an abutment edge to enclose the laundry detergent molding in an accommodation space defined by the container shells 4.

13. The container as claimed in claim 1, wherein the container shells are flexible.

14. The container as claimed in claim 6, wherein material bonding is selected from the group consisting of sintering and adhesive bonding.

15. A container for a compacted molded laundry detergent tablet, comprising:
a first shell portion formed as a series of individual generally spherical bodies in an array in which adjacent generally spherical bodies are connected to one another at points of contact and define interspaces between generally spherical bodies through which washing water may flow; and
a second shell portion formed as a series of individual generally spherical bodies in an array in which adjacent generally spherical bodies are connected to one another at points of contact and define interspaces between generally spherical bodies through which washing water may flow;
wherein said first and second shell portions when connected together define an inner accommodation space for the laundry detergent tablet.

16. The container as claimed in claim 15, wherein the first and second shell portions are hemispherical.

17. The container as claimed in claim 15, wherein the arrays of generally spherical bodies in each of the first and second shell portions defines multiple rows, with each spherical body in contact with adjacent spherical bodies in its row.

18. The container as claimed in claim 17, wherein each individual body is in contact with at least four of the individual bodies surrounding it in the array.

19. The container as claimed in claim 15, wherein the first and second shell portions are flexible.
